(19) United States
(12) Patent Application Publication
(10) Pub. No.: US 2016/0064783 A1
(43) Pub. Date: Mar. 3, 2016

(54) TRACTION BATTERY THERMAL MANAGEMENT APPARATUS AND METHOD

(71) Applicant: FORD GLOBAL TECHNOLOGIES, LLC, Dearborn, MI (US)

(72) Inventors: Steven F. CHORIAN, Canton, MI (US); George Albert GARFINKEL, Westland, MI (US); Dhanunjay VEJALLA, Novi, MI (US); Sai K. PERUMALLA, Rochester Hills, MI (US); Steven DROSTE, Ypsilanti, MI (US)

(21) Appl. No.: 14/476,045

(22) Filed: Sep. 3, 2014

(51) Int. Cl. H01M 10/625; H01M 10/6551; H01M 10/6555; H01M 10/6552; H01M 10/6557; H01M 10/613; H01M 10/656

(52) U.S. Cl. CPC H01M 10/625; H01M 10/613; H01M 10/6551; H01M 10/656; H01M 10/6552; H01M 10/6557; H01M 10/6555; H01M 2220/20

(57) ABSTRACT

A vehicle traction battery heat sink includes a first fin having a cell contact portion in thermal contact with a plurality of battery cells. The first fin also includes a connector portion extending from the cell contact portion. The heat sink further includes a thermal plate in thermal contact with the connector portion and a thermal agent circulated within the thermal plate. The heat sink allows heat generated by the plurality of battery cells to be transferred through the fin to the thermal plate.

### TECHNICAL FIELD

The present disclosure relates to thermal management of vehicle traction batteries used to operate hybrid and electric vehicles.

### BACKGROUND

Hybrid and electric vehicles commonly demand significant amounts of energy from a high voltage traction battery. The energy may be used to drive motors and electrical accessories. The traction batteries can include a large number of interconnected battery cells. Maintaining battery temperature within a desired operating range may promote proper battery function and enhance battery longevity. Also, it may be beneficial to limit the differential in temperature across individual cells. Thermal management devices may be used to regulate battery temperature. For example, directing passenger cabin air or external air across a battery may help regulate temperature. Additionally, electric heating systems may be used to warm a battery during low temperature conditions.

### SUMMARY

In at least one embodiment, a vehicle traction battery heat sink includes a first fin having a cell contact portion in thermal contact with a plurality of battery cells. The first fin also includes a connector portion extending from the cell contact portion. The heat sink further includes a thermal plate in contact with the connector portion and a thermal agent circulated within the thermal plate. The heat sink allows heat to be exchanged between the plurality of battery cells and the thermal plate through the first fin.

In at least one embodiment, a vehicle traction battery includes a plurality of adjacent battery cell arrays. The traction battery also includes a plurality of fins interleaved between the cell arrays, each fin including a cell contact portion in thermal contact with a cell array. Each of the fins also includes a connector portion beneath a cell array. The traction battery further includes a thermal plate in contact with the connector portion of each fin. The connector portion of each fin engages adjacent connector portions to provide a substantially continuous base surface across the plurality of cell arrays.

In at least one embodiment, a vehicle traction battery assembly includes a plurality of battery cells arranged in an array, the array having a first row of battery cells and a second row of battery cells. The traction battery also includes a first fin abutting an exterior surface of the first row of battery cells. A second fin abuts an exterior surface of both of the first row and the second row of battery cells. The traction battery further includes a thermal plate disposed beneath the array and in thermal contact with the first fin and the second fin, wherein heat is exchanged between battery cells and the thermal plate by conduction transfer through the first fin and the second fin.

### BRIEF DESCRIPTION OF THE DRAWINGS

FIG. 1 is a schematic of a plug-in hybrid-electric vehicle.

FIG. 2 is an exploded view of a cell array of a traction battery assembly.

FIG. 3 is a perspective view of an assembled traction battery assembly having two adjacent cell arrays.

FIG. 4 is a perspective view of an alternate embodiment traction battery assembly.

FIG. 5 is a schematic side view of an additional alternate embodiment traction battery assembly having a coolant manifold.

FIG. 6 is a partial perspective view of the traction battery assembly of FIG. 5.

FIG. 7 is a schematic side view of the traction battery assembly having a conductive plate to connect a fin to a thermal plate.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

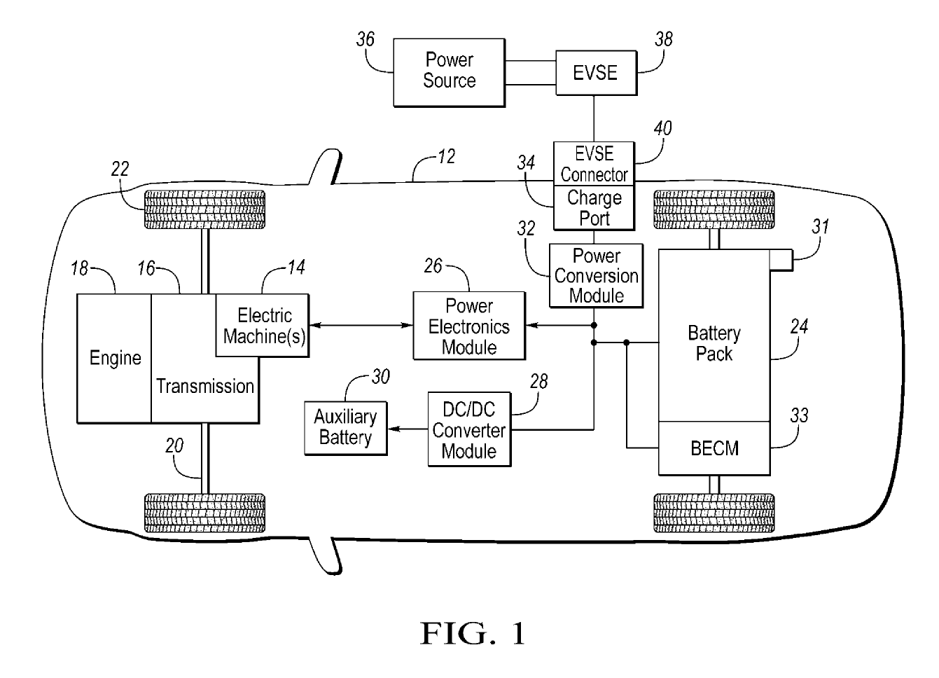

FIG. 1 depicts a schematic of a plug-in hybrid-electric vehicle (PHEV). The vehicle 12 includes one or more electric machines 14 mechanically connected to a hybrid transmission 16. The electric machines 14 may be capable of operating as a motor or a generator to receive or provide electrical power, respectively. In addition, the hybrid transmission 16 may be mechanically connected to an engine 18. The hybrid transmission 16 may also be mechanically connected to a drive shaft 20 that is mechanically coupled to the wheels 22. The electric machines 14 can provide propulsion and deceleration capability when the engine 18 is turned on or off. When the electric machines 14 are operated as generators, they may provide fuel economy benefits by recovering energy during deceleration through regenerative braking. The electric machines 14 reduce pollutant emissions and increase fuel economy by reducing the work load of the engine 18.

A traction battery or battery pack 24 stores energy that can be used by the electric machines 14, as well as other vehicle accessories having an electrical load. The traction battery 24 may provide a high voltage direct current (DC) output from one or more battery cell arrays, sometimes referred to as battery cell stacks, within the traction battery 24. The battery cell arrays may include one or more battery cells.

The battery cells, such as a prismatic, cylindrical, or pouch cells, may include electrochemical cells that convert stored chemical energy to electrical energy. The cells may further include a housing, a positive electrode (cathode) and a negative electrode (anode). An electrolyte may allow ions to move between the anode and cathode during discharge, and then return during recharge. Terminals may allow current to flow out of the cell for use by the vehicle. When positioned in an array with multiple battery cells, the terminals of each battery cell may be aligned with opposing terminals (positive and negative) adjacent to one another and a busbar may assist in facilitating an electrical series connection between the multiple battery cells. The battery cells may also be arranged in parallel such that similar terminals (positive and positive or negative and negative) are adjacent to one another.

Different battery pack configurations may be available to address individual vehicle variables including packaging constraints and power requirements. The battery cells may be thermally regulated with a thermal management system. Examples of thermal management systems may include air cooling systems, liquid cooling systems and a combination of air and liquid systems.

The traction battery 24 may be electrically connected to one or more power electronics modules 26. One or more contactors may isolate the traction battery 24 from other components when opened and connect the traction battery 24 to other components when closed. The power electronics module 26 may also be electrically connected to the electric machines 14 and regulate bi-directional transfer of electrical energy between the traction battery 24 and the electric machines 14. For example, a traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a pure electric vehicle. In a pure electric vehicle, the hybrid transmission 16 may be a gear box connected to an electric machine 14 and the engine 18 is not present.

As discussed above, the traction battery 24 may provide energy for other vehicle electrical systems in addition to providing energy for propulsion. A vehicle power system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. In certain vehicles, the low-voltage systems are electrically connected to an auxiliary battery 30 (e.g., a 12 volt battery).

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24. Although a single temperature sensor is depicted in the schematic of FIG. 1, multiple sensors may be employed to individually monitor separate cells and/or arrays of cells within the traction battery 24.

The battery pack 24 may be recharged by an external power source 36, for example, such as an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via dedicated electrical conduits.

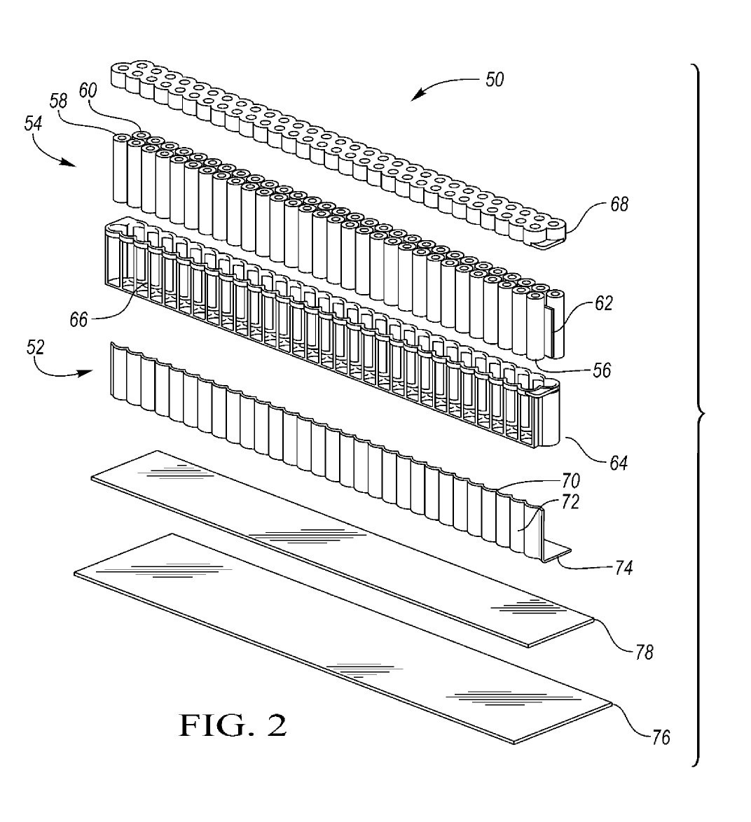

Referring to FIG. 2, a vehicle traction battery 50 includes a heat sink 52 for managing the temperature of the battery through the conduction of heat. The heat sink 52 may be used to dissipate heat from the traction battery 50 in high temperature conditions. Alternatively, the heat sink may receive heat and be used to warm the traction battery 50 in low temperature conditions. The traction battery 50 also includes a battery array 54 made up of a plurality of battery cells 56 electrically connected to each other to achieve a desired voltage. By way of example, the battery array 54 has a first row 58 of battery cells and a second row 60 of battery cells. The total number of battery cells and number of rows of battery cells can differ from the example provided. An insulator 62 may be positioned between the first row 58 and the second row 60 of battery cells to electrically insulate the rows of battery cells from each other. A traction battery case 64 may be provided to hold the battery cells 56 in position with respect to each other. The traction battery case 64 may be a molded plastic and include a rail on opposing sides as well as a base to support the battery array 54. The traction battery case 64 may also include an openings 66 arranged so that a significant portion of the sides of each battery cell is not covered by the traction battery case 64. The openings 66 may allow the heat sink 52 to disperse heat from the battery array 54 while the cells are retained by the battery case 64. A battery cap 68 electrically connects the battery cells 56 of the battery array 54 and may include bus bars and voltage sensors. The battery cap 68 is positioned on top of battery terminals of the battery cells 56.

Battery cells 56 may generate heat when in use. In this case, the heat sink 52 dissipates heat from the battery cells to help manage an overall temperature of the battery. Conversely, in cold ambient conditions heat may be imparted to the heat sink 52 to deliver heat to the battery cells 56. The heat sink 52 includes a fin 70 made of a thermally conductive material. For example, aluminum, copper, graphite, or CarbAl™, among other materials, may be suitable for exchanging heat. Alternatively, the fin 70 may be formed from a plastic composition.

The fin 70 has a cell contact portion 72 that is in thermal contact with a side of a row of battery cells 56, such as the first row 58. The cell contact portion 72 may be pliable and conform to an external surface of the row of battery cells when assembled. In other embodiments, the cell contact portion 72 may be pre-formed having a corrugated shape that conforms to the sides of a plurality of cylindrical battery cells 56. In either case the cell contact portion nests with the corresponding external battery shapes to maximize the amount of surface area in direct contact with the external side of each battery cell 56. A large surface area of direct contact may increase heat transfer between the battery cells 56 and the fin 70. In at least one embodiment, the battery cells 56 are cylindrical in shape, and the cell contact portion 72 includes a series of curved portions that conform to the corresponding shape of cylindrical battery cells 56.

The fin 70 also has a lower connector portion 74 extending laterally from the cell contact portion 72. In configurations where the battery cells are arranged in an upright orientation, the lower connector portion 74 provides an additional base surface layer for supporting the battery array 54. The lower connector portion 74 further adds a thermally conductive surface area for exchanging heat between the battery cells and a thermal plate 76. In certain alternative embodiments, the lower connector portion 74 may not be provided, and the fin 70 is directly attached to the thermal plate 76.

The thermal plate 76 may be formed from thermally conductive material having an internal cavity to accommodate a thermal agent, such as a fluid coolant. For example, the thermal agent may be a coolant liquid such as a fifty percent mixture of water and glycol. The coolant may be additionally mixed with various other agents having high heat transfer properties. Other alternative fluids may also be suitable, including various refrigerants.

The thermal agent may be circulated within the thermal plate 76 through an inlet connected to a thermal agent reservoir and an outlet connected to a discharge tank. A pattern of conduits may route the flow of the thermal agent in a desired pattern within the internal cavity of the thermal plate. In at least one embodiment, the thermal agent is cycled through the thermal plate in a serpentine pattern.

The heat sink 52 may include a thermal interface material 78, also referred to as TIM, positioned between the fin 70 and the thermal plate 76. In embodiments where a lower connector portion 74 is provided, the thermal interface material 78 may be positioned between the lower connector portion 74 and the thermal plate 76. The thermal interface material 78 may be formed from a di-electric material and provide electrical insulation between the battery cells 56 and the thermal plate 76. Also, the thermal interface material 78 may be compressible and conform to surface transitions and irregularities on the underside of the fin 70 or the battery array 54. The conformity of the interface material 78 enhances the thermally conductive surface area contact, thereby improving the heat transfer between the battery cells 56 and the thermal plate 76. For example, the thermal interface material 78 enhances the heat transfer by filling any voids or gaps between the fin 70 and the thermal plate 76.

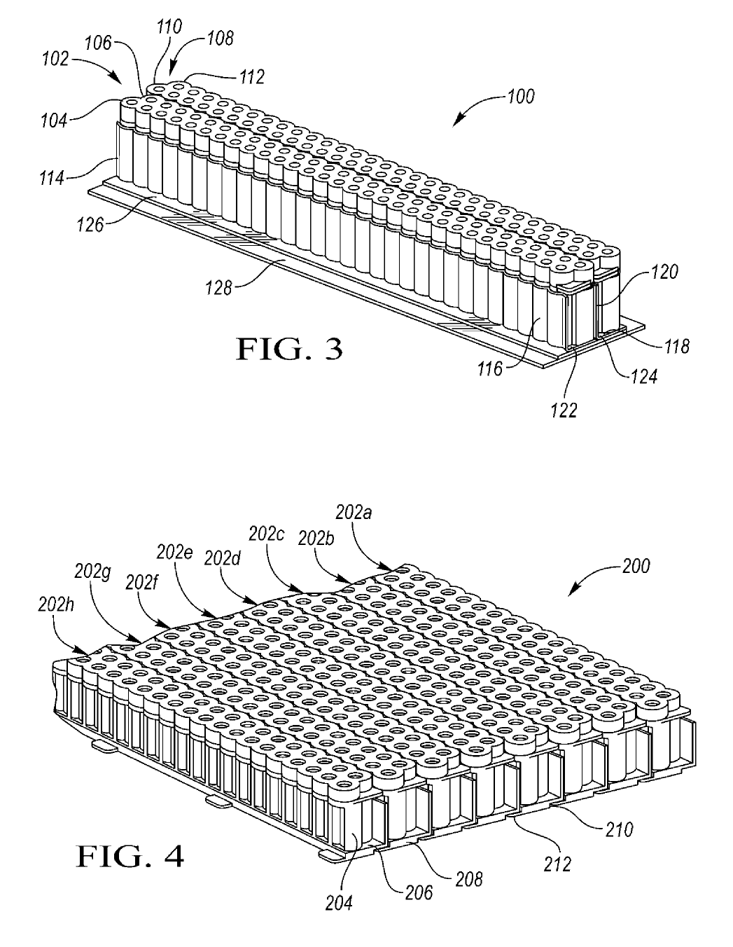

Referring to FIG. 3, a traction battery assembly 100 includes two adjacent arrays of battery cells. A first battery array 102 has a first row of battery cells 104 and a second row of battery cells 106. A second battery array 108 has a first row of battery cells 110 and a second row of battery cells 112. A fin 114 is provided for each battery array such that a cell contact portion 116 directly contacts a plurality of individual cells. For instance, an exterior surface of the first row of battery cells 104 is in thermal contact with the cell contact portion 116 of the fin 114. A second fin 118 is also provided, and its cell contact portion 120 is in thermal contact with both of an exterior surface of the second row of battery cells 106 of the first battery array 102, as well as an exterior surface of the first row of battery cells 110 of the second battery array 108. Since the second row of battery cells 106 and the first row of battery cells 110 share portions of fin 118, the first battery array 102 and the second battery array 108 may be offset with respect to each other to allow the shapes of the respective battery cells to nest with each other. In this way, the shape of a single cell contact portion 120 conforms to, and is in thermal contact with, a plurality of rows of cells. As discussed above, the cell contact portions may be pliable and conformed during assembly, or be pre-formed and nest with the external shapes of the battery cells. This arrangement may maximize the battery cell density within the traction battery assembly 100 and at the same time provide efficient heat transfer between the battery cells and the fins 114, 118.

Each of the first fin 114 and the second fin 118 has a lower connector portion 122, 124, respectively. The first battery array 102 and the second battery array 108 may also lay on a thermal interface material 126 and a thermal plate 128. The thermal interface material 126 can be positioned between the lower connector portions 122, 124 and the thermal plate 128.

As discussed above different quantities of cell rows and/or cell arrays may be suitable depending upon the desired application. Referring to FIG. 4, a traction battery assembly 200 includes eight battery cell arrays 202a through 202h. Each row of each array directly contacts a fin so that respective battery cells may be either cooled or warmed depending on the operating conditions. In order to achieve more densely packed battery cells and avoid having a thermal plate connector that protrudes from the exterior of the traction battery assembly, the outermost row 204 of battery cell array 202h has a fin 206 with no thermal plate connector. Alternatively, the outermost row 204 of battery cell array 202h may be provided with no fin. Each of battery cell arrays 202a through 202h may be provided with its own fin, thermal interface material, and thermal plate. Alternatively, the battery cell arrays 202a through 202h may share a single thermal interface material and a single thermal plate.

Still referring to FIG. 4, each of the fins may be arranged to contact an adjacent fin at the lower connector portion. For example, the lower connector portion 208 may include notched portions, or rabbets, to interface with adjacent fins. A first notched portion 210 disposed near the cell contact portion of the fin may engage a second notched portion 212 on an upper surface of the lower connector portion 208 of an adjacent fin. The engagement between the first notched portions 210 and the second notched portions 212 may effectively create lap joints to provide a continuous base surface beneath the plurality of battery cell arrays 202a through 202h. In at least one embodiment, the connector portion 208 of each fin interlocks the connector portion of an adjacent fin. In further embodiments, tongues and grooves, or dovetail joints may also be suitable to provide a continuous mounting surface beneath the battery cell arrays.

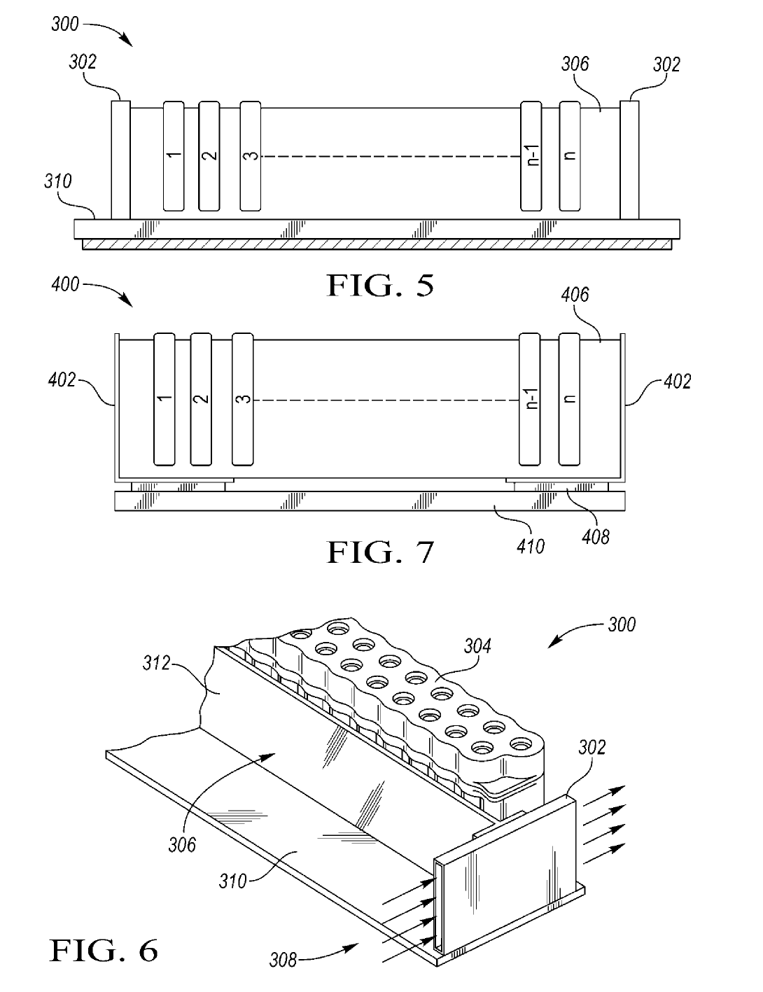

Referring to FIGS. 5 and 6, an additional mechanism for promoting heat transfer includes a heat sink in cooperation with one or more manifolds. FIG. 5 is a schematic diagram of a battery pack assembly 300 having two manifolds 302, each at opposing ends of the battery pack assembly. FIG. 6 is a cutaway perspective view of the battery pack 300 partially assembled. Similar to previous embodiments, the battery pack assembly 300 includes a number of battery arrays 304 having a series of cells. The total quantity of cells may vary across different applications and is depicted by a quantity “n” in the schematic of FIG. 5. At least one fin 306 is disposed between, and is in thermal contact with, two adjacent arrays within the battery pack assembly 300.

Manifolds 302 include coolant inlet and outlet ports, and are disposed near an end portion of each of the fins 306. A thermal agent may flow through the manifolds 302 to further manage the temperature of the battery cells. Similar to the behavior of the thermal plate discussed above, one or more manifolds may be used to either cool or warm the battery cells depending on the operating conditions. An example direction of fluid flow is depicted by arrows 308 of FIG. 6. The manifolds 302 may also be in fluid flow connection with a thermal plate 310 disposed beneath the battery cell arrays 304. Under warm conditions, the battery cells dissipate heat to the cell contact portion of the fin 306. Where applicable, battery cells further dissipate heat to the thermal plate connectors of the fins 306. The fins 306 transfer heat to the thermal interface material, the thermal plate 310, and the manifolds 302. Conversely, under cold conditions the thermal plate 310 and the manifolds 302 can be used as a heat source and heat is transferred in the reverse direction to the battery cells. While FIG. 6 depicts a version of a fin having a cell contact portion 312 that is in the form of a flat wall, it should be noted that a corrugated shape as discussed above may be applied in conjunction with manifolds to increase surface area contact between fins and battery cells.

FIG. 7 shows an additional mechanism for operating a heat sink to regulate battery cell temperature. A battery pack assembly 400 includes a plurality of cell arrays including a quantity of individual cells. The total quantity of cells may vary across different applications and is depicted by a quantity “n” in the schematic of FIG. 7. Similar to previous embodiments, one or more fins 406 may be arranged between the cell arrays to contact the cells and dissipate heat. Conductive plates 402 having a right angle bend are disposed at each opposing end of the fins 406. The conductive plates 402 also contact a thermal interface material 408 at a lower contact portion beneath the cell arrays. The thermal interface material 408 is in contact with a thermal plate 410. The battery cells exchange heat with the thermal plate 410 by conduction through the fins 406, the conductive plates 402, and the thermal interface material 408.

The present disclosure provides heat sink for a traction battery that employs a unique configuration of multiple components to efficiently dissipate heat. The heat sink allows the battery cells to provide energy to the vehicle and helps to prevent overheating of the battery cells. The heat sink adds durability to the traction battery assemblies. In certain embodiments, the heat sink includes fins that conform to the shape of the battery cells thereby minimizing the amount of space needed for the traction battery assembly. The traction battery assemblies of the present disclosure have battery cells and heat sinks that are densely packed to minimize space required to position the battery within a vehicle. Although not always explicitly illustrated, one of ordinary skill in the art will recognize that one or more of the illustrated component or functions may be duplicated in a thermal management device depending upon the particular strategy being used.

While several embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle traction battery heat sink comprising:
a first fin having a cell contact portion in thermal contact with a plurality of battery cells and a connector portion extending from the cell contact portion; and
a thermal plate in thermal contact with the connector portion and having a thermal agent circulated within the thermal plate, wherein heat is exchanged between the plurality of battery cells and the thermal plate through the fin.

2. The vehicle traction battery heat sink of claim 1 further comprising a thermal interface material positioned in between the connector portion and the thermal plate, wherein the heat from the battery cells is transferred from the fin, through the thermal interface material, and to the thermal plate.

3. The vehicle traction battery heat sink of claim 1 wherein the cell contact portion of the fin is pliable and conforms to an external surface of a plurality of battery cells arranged in an array to create a surface area contact.

4. The vehicle traction battery heat sink of claim 1 wherein the cell contact portion of the fin is pre-formed having a corrugated shape to nest with a corresponding external surface of a plurality of battery cells arranged in an array to create surface area contact.

5. The vehicle traction battery heat sink of claim 1 wherein the plurality of battery cells are arranged in adjacent arrays and the cell contact portion of the fin is in surface area contact with each of two adjacent arrays.

6. The vehicle traction battery heat sink of claim 1 further comprising a manifold in fluid flow connection with the thermal plate, wherein the manifold exchanges heat with the fin through contact with an end of the fin.

7. The vehicle traction battery heat sink of claim 1 further comprising a second fin having a cell contact portion and a connector portion wherein the connector portion of the first fin interlocks with the connector portion of the second fin.

8. A vehicle traction battery comprising:
a plurality of adjacent battery cell arrays;
a plurality of fins, each including a cell contact portion in thermal contact with a cell array and a connector portion beneath a cell array; and
a thermal plate in contact with the connector portion of each fin, wherein the connector portion of each fin engages adjacent connector portions to provide a substantially continuous mounting surface across the plurality of cell arrays.

9. The vehicle traction battery of claim 8 further comprising a thermal interface material positioned between the connector portion of each fin and the thermal plate such that heat is transferred between the battery cell arrays and the thermal plate through the fin and the thermal interface material.

10. The vehicle traction battery of claim 8 further comprising a manifold in thermal contact with an end portion of the fin, the manifold being adapted to circulate a thermal agent through an internal cavity to exchange heat with an end portion of at least one fin.

11. The vehicle traction battery of claim 10 wherein the manifold is in fluid flow connection with the thermal plate to circulate the thermal agent within the thermal plate.

12. The vehicle traction battery of claim 8 wherein the cell portion is preformed to a corrugated shape to nest with an external shape of a plurality of battery cells to create a surface area contact.

13. The vehicle traction battery of claim 8 wherein the cell portion of each of the plurality of fins is pliable and conforms to an external shape of a battery cell array to create a surface area contact.

14. A vehicle traction battery assembly comprising:
a plurality of battery cells arranged in an array, the array having a first row of battery cells and a second row of battery cells;
a first fin abutting an exterior surface of the first row of battery cells;
a second fin abutting an exterior surface of both of the first row and the second row of battery cells; and
a thermal plate disposed beneath the array and in contact with the first fin and the second fin, wherein heat is exchanged between the battery cells and the thermal plate by conduction transfer through the first fin and the second fin.

15. The vehicle traction battery assembly of claim 14 further comprising a compressible thermal interface material disposed between each of the first and second fins and the thermal plate, wherein the heat exchanged between the battery cells to the thermal plate is conducted through the first fin, the second fin, and the thermal interface material.

16. The vehicle traction battery assembly of claim 14 wherein a thermal agent is circulated through the thermal plate.

17. The vehicle traction battery assembly of claim 14 further comprising a manifold in fluid flow connection with the thermal plate wherein the manifold contacts an end portion of each of the first fin and the second fin to exchange heat with the battery cells.

18. The vehicle traction battery assembly of claim 14 wherein the first fin is pliable to conform to the exterior surface of the first row of battery cells.

19. The vehicle traction battery assembly of claim 14 wherein the first fin and the second fin each define a cell contact portion in thermal contact with the plurality of battery cells, and further define a connector portion that extends laterally from the cell contact portion, the connector portion in contact with the thermal plate.

20. The vehicle traction battery assembly of claim 19 wherein the connector portion of the first fin engages the connector portion of the second fin to define a lap joint thereby creating a substantially continuous base beneath the array.
